(19) United States
(12) Patent Application Publication
(10) Pub. No.: US 2007/0101946 A1
(43) Pub. Date: May 10, 2007

(54) Dog Toy Toothbrush

(76) Inventor: Barbara Penny, Edison, NJ (US)

Correspondence Address: GREENBERG & LIEBERMAN, LLC, 2141 WISCONSIN AVE, N.W., SUITE C-2, WASHINGTON, DC, 20007, US

(21) Appl. No.: 11/164,038

(22) Filed: Nov. 8, 2005

(51) Int. Cl. A01K 29/00

(52) U.S. Cl. 119/709

(57) ABSTRACT

A toothbrush and chew-type toy for a dog. The toothbrush is comprised of a main body, and a first end with two nubs and a second end with bristles. The first end nubs allow said toothbrush to be held between the dog's front paws, and the brush can be held upright by the dog. The dog can therefore brush its own teeth without the assistance of a person. The main body of the present invention is made of a chew material similar to Nylabone, which additionally works the dog's gums.

### FIELD OF THE INVENTION

The present invention relates to a toothbrush, and more particularly, to a toothbrush designed for a dog so that the dog can brush its own teeth.

### BACKGROUND OF THE INVENTION

Just like people, dogs need to brush their teeth. Unfortunately, dogs do not have the dexterity, nor the fingers on hands, to be able to hold a toothbrush and actually brush their teeth. Thus, typically, the owner of a dog will use a conventional toothbrush, or many dog toothbrushes that are conventionally available on the market, to brush the dog's teeth. There is a need for a toothbrush that allows a dog to brush its own teeth without user invention.

U.S. Design Patent No. 337,398 issued on Jul. 13, 1993, to Axelrod shows a dog toy with nubs on its exterior. Unlike the present invention, Axelrod's device is not elongated to extend into the dog's mouth to its rear teeth. Furthermore, unlike the present invention, Axelrod's device is not shaped like a bone to encourage the dog to actually use the toy.

U.S. Pat. No. 6,116,191 issued on Sep. 12, 2000, to Suchowski et al shows a composite chew toy. Unlike the present invention, Suchowski et al's device merely has the rows of nubs along the entire length of the device. Unlike the present invention, Suchowski et al's device does not resemble a toothbrush.

U.S. Pat. No. 5,263,436 issued on Nov. 23, 1993, to Axelrod shows a bone-shaped therapeutic device for dogs. Unlike the present invention, Axelrod's device has nubs along the entire surface of the device. Further, unlike the present invention, Axelrod's device does not have bristles.

U.S. Patent Application Publication No. U.S. 2002/0083539A1, published on Jul. 4, 2002, and invented by Bella, shows an animal toothbrush for pets and animals. It has a front end and a back end with bristles. Unlike the present invention, Bella's device does not resemble a dog bone. Moreover, unlike the present invention, Bella's device cannot be held by a dog easily against the ground to reach its rear teeth.

U.S. Pat. No. 6,769,828 issued to Clark on Aug. 3, 2004, shows a chewable toothbrush. Unlike the present invention, Clark's device does not resemble a bone. Moreover, unlike the present invention, Clark's device does not have one end adapted to be held against the ground to allow a dog to reach the back of its teeth.

U.S. Pat. No. 6,739,287 issued to Sarantis, granted on May 25, 2004, shows a dog toy and toothbrush system and a method. Unlike the present invention, Sarantis does not present bristles external of the device. Moreover, unlike the present invention, Sarantis's device does not have one end adapted to be held against the ground, while the opposite end can reach the back of the dog's mouth to scrub the rearmost teeth of the dog.

U.S. Pat. No. 6,582,224 issued to Lilien et al on Jun. 24, 2003, shows an animal toothbrush. Lilien's device is a powered rotational toothbrush for cleaning the teeth of a dog. Unlike the present invention, Lilien's device does not resemble a dog bone. Moreover, unlike the present invention, Lilien's device must be operated by a user other than the dog, such as the dog owner.

U.S. Pat. No. 5,944,516 issued to Deshaies on Aug. 31, 1999, shows an animal tooth-cleaning device and method. Deshaies' device is designed so that when an animal bites against its shell, the shell is compressed and causes brushes to protrude from the shell and exert a cleaning effect on the animal's teeth. Unlike the present invention, Deshaies' device does not resemble a bone. Moreover, unlike the present invention, Deshaies' device does not even resemble a conventional toothbrush. Moreover, unlike the present invention, Deshaies' device does not have one end that can be pressed against the ground and pivoted, so that a dog can reach its rearmost teeth because Deshaies' device is not terribly elongated.

U.S. Pat. No. 4,924,811 granted to Axelrod on May 15, 1990, shows a therapeutic device for cleaning the teeth of dogs. Axelrod's device has an annealed nylon rope formed with one or more knots held by a dog or by a human to enable an untwisted tassel portion of the rope to be pulled between a dog's teeth in the manner of dental floss. Unlike the present invention, Axelrod's device does not present bristles for brushing a dog's teeth. Further, unlike the present invention, Axelrod's device is not intended to be used by a dog alone, so that it can reach its back teeth in a brushing fashion. Further, unlike the present invention, Axelrod's device does not resemble a bone to encourage a dog to use it.

U.S. Pat. No. 4,738,001 issued to Shipp on Apr. 19, 1998, shows a canine and feline toothbrush. Unlike the present invention, Shipp's device does not resemble a dog bone. Moreover, unlike the present invention, Shipp's device does not allow a dog to work its gums, or exercise its gums, in addition to brushing its teeth.

Japanese Patent Publication No. 2,000,350,529A, invented by Axelrod, and published on Dec. 19, 2000, shows an animal chew device having a low voltage battery, such that ultrasonic sound waves are generated to remove dental plaque from the animal's teeth and gums. Unlike the present invention, Axelrod's device does not have bristles. Furthermore, unlike the present invention, Axelrod's device does not resemble a conventional toothbrush that would be used even by a human, so that its range in the dog's mouth is very limited to the shape of the bone that it imitates.

Thus, there is a need for a toothbrush for a dog that resembles a bone to encourage the dog to actually use the device. Moreover, there is a need for a toothbrush that the dog can use by itself. This means that the toothbrush must be capable of being held by the dog, or pushed by the dog against the floor or some other surface, so that the dog can stabilize it to reach back teeth. Moreover, there is a need for a toothbrush that resembles a conventional human toothbrush, so that the same beneficial effects of bristles, [as well as the curvature of the head from the main body,] as well as some sort of handle, exists so that the dog's teeth can be brushed properly, just as a human would brush its own teeth.

### SUMMARY OF THE INVENTION

The present invention is a dog toothbrush that resembles a conventional human toothbrush. However, it is modified so that a dog can actually hold it, use it and would be attracted to it, so that its use would be encouraged.

One end of the present invention is shaped like the end of a dog bone, so that the present invention actually visually appeals to a dog because it looks like a conventional dog bone. That end is also important because it presents two nubs that could be held against the ground, so that the dog can balance that end of the toothbrush against the floor or the ground when extending the opposite end into the dog's mouth.

Further, the main body of the invention has a Nylabone trademark, or similar type chew bone, so that the dog can actually bite across the main body of the device and work its gums.

In addition, the present invention tapers and then has a curvature, much like the part of a conventional human toothbrush that would be right under the bristle area. The curvature allows the present invention to have bristles that are disposed, offset and at an angle away from the main body of the present invention, so that the bristles can actually reach the back teeth of the dog.

The bristles are conventional bristles and a hard nylon top is there so that the dog can't actually bite and break off the bristle portion of the present invention and choke.

### BRIEF DESCRIPTION OF THE DRAWINGS

FIG. 1 shows an environmental perspective view of the present invention.

FIG. 2 is a side view of the present invention.

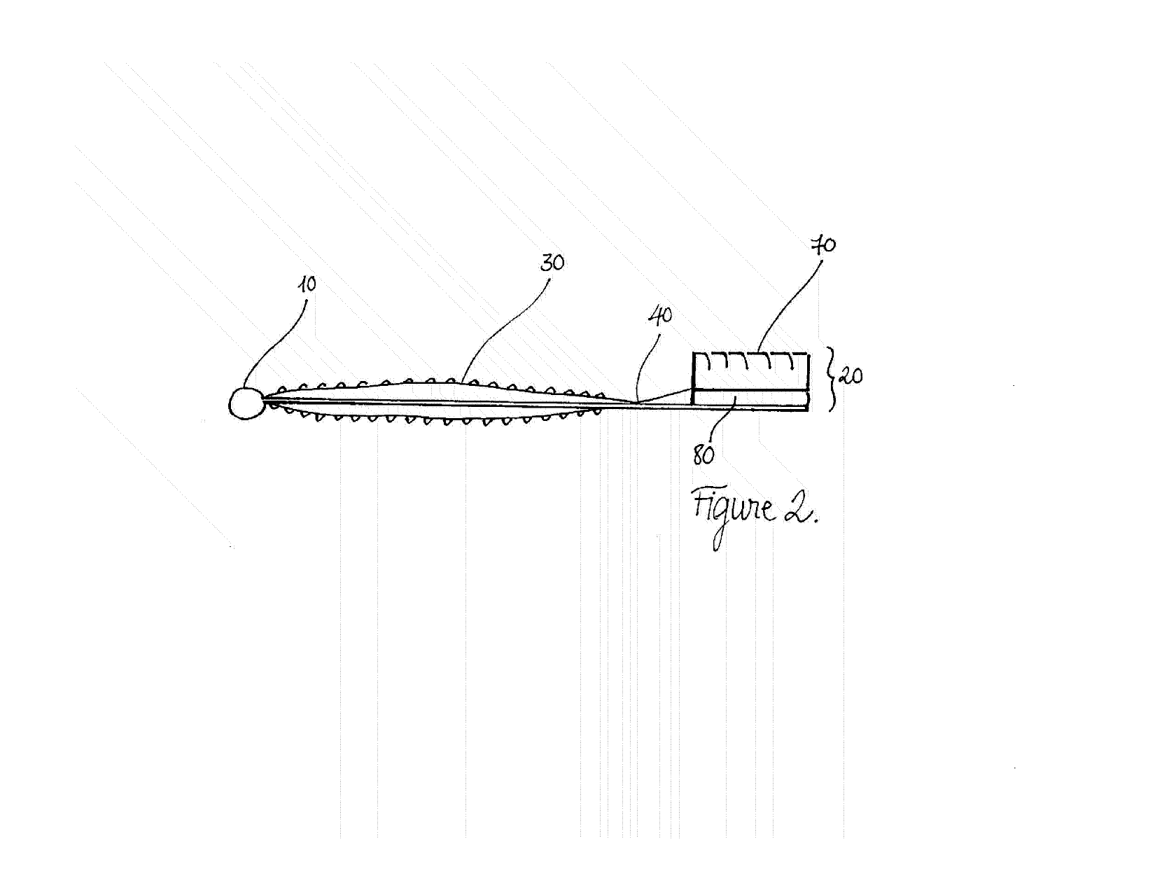

### DETAILED DESCRIPTION OF THE PREFERRED EMBODIMENT

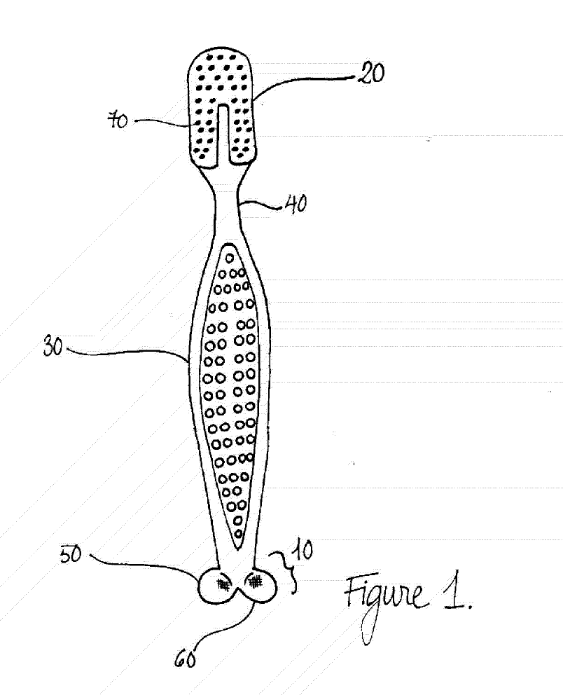

As shown in FIG. 1, the present invention has a first end (10), a second end (20), a main body (30), and a neck portion (40). Thus, from one end to the other, the present invention has forced end (10) in communication with main body (30) in communication with neck portion (40) in communication with second end (20). First end (10) is made to resemble the end of a conventional dog bone. Thus, first end (10) has a first nub (50) and a second nub (60).

Second end (20) has bristles (70) disposed on backing (80). Bristles (70) are conventional bristles that one would find on a toothbrush and they can be formed in any conventional shape, such that as bristles (70), for example, are elongated as they move medial to the present invention and are shortened as they move lateral from the present invention. Also, as bristles (70) move lateral from the present invention, fewer bristles (70) can be disposed on backing (80), such that a point formation is formed at the end-most point of second end (20).

In short, various configurations of bristles (70), just as in conventional human toothbrushes, can be used in the present invention. The goal is to brush the dog's teeth with a bristle (70) configuration and is actually particularly designed for different dogs. Thus, hard bristles, soft bristles, varying conventional densities of bristles can be used. Bristle (70) can be used on backing (80).

Because a dog obviously does not have hands and only has paws, the present invention is designed so that the dog can use the present invention with similar dexterity to a conventional human toothbrush. In use, the present invention would be held by a dog's paws, such that the first end (10) rests on the ground or the floor. The present invention would then extend perpendicular, or roughly perpendicular, to the plane of the floor, such that second end (20) would be held high above the floor, and could be inserted into the dog's mouth.

Because the dog's paws can be placed along either side of the present invention, most typically along main body (30), the dog will be able to stabilize the present invention from moving side-to-side. And because first end (10) has first nub (50) and second nub (60), the dog is able to balance first nub (50) and second nub (60) against the ground to prevent the present invention from slipping, as the present invention is inserted into the dog's mouth.

Essentially, the dog can apply pressure to the present invention when inserting second end (20) into the dog's mouth, and so long as the dog's paws remain around main body (30), first nub (50) and second nub (60) will provide a surface against the floor or ground so that the present invention can reliably be held by the dog.

It is important to note that backing (80) of the present invention must be made thin enough that it will not interfere with the dog inserting second end (20) into the dog's mouth. However, backing (80) must be made of a very hard nylon, such that it is somewhat flexible, will not shatter, will not crumble, but at the same time, it must provide some sort of structural rigidity so that bristle (70) can be pressed against the dog's teeth and gums to further allow a dog similar flexibility in brushing its teeth, just as a human would desire.

The present invention has neck portion (40). Neck portion (40) can be made of the same hard nylon material as backing (80). Neck portion (40) can be straight, but it is preferred that it is offset from the plane of main body (30). Thus, neck portion (40) would allow second end (20), once inserted into the dog's mouth, to curve, or reach the back and outermost teeth of the dog.

Main body (30) of the present invention is preferably made of a Nylabone trademark type material, or a similar chew bone type material, such that in addition to brushing the dog's teeth, the dog can actually chew and exercise its gums. If the dog were to use the present invention to exercise its gums and chew, most likely first end (10) and second end (20) would be to the left and right, or vice versa, of the dog, and the dog would chew on the present invention just like a conventional bone.

It is important to recognize, however, that in addition to providing a Nylabone type material, Nylabone trademark type material, or similar chew bone type material surface, the present invention also has a toothbrush that can be manipulated solely by the dog to brush its teeth. Thus, in addition to being a toothbrush that the dog can use, and in addition to being a chew-type toy that the dog can chew on, the present invention is both.

It is contemplated that a dog could flip the present invention around, such that instead of brushing its teeth with first end (10) against the ground and second end (20) inserted into its mouth, a dog would hold the present invention with second end (20) against the ground and first end (10) in its mouth. Again, if the dog used the present invention in such a way, it would really be chewing on first nub (50), second nub (60) and main body (30), which are all formed of the Nylabone trademark type material or similar chew bone type material.

Because first nub (50) and second nub (60), in combination with main body (30), look similar to a conventional dog bone, the dog will be encouraged to use the present invention as a chew toy to exercise its gums and not just as a toothbrush.

It is contemplated that the present invention will come in three or four sizes. One size would be intended for small dogs that are under 15 pounds. Another size would be intended for medium dogs that are roughly 15 to 35 pounds. A third size would be for large dogs that are roughly 35 to 55 pounds. And a fourth size would be for extra-large dogs that are 50 to 80 pounds. The different sizes of the present invention would be necessary because different size dogs will need different size toothbrushes to reach the back of their teeth and all around the gums and surface areas inside their mouths. Dogs over 80 pounds would need an even larger size of the present invention, not just in thickness because such large dogs will have strength to snap the present invention, but a much more elongated version of the present invention would be necessary, with the same parts as outlined already, to reach large dogs' rear teeth and all surfaces within their mouths.

The present invention is not limited to the embodiments described above, and it is contemplated that any and all embodiments of the present invention within the scope of the following claims are part of the present invention.

What is claimed is:

1. A toothbrush for a dog, comprised of:
a first end;
a second end; and
a main body.

2. The toothbrush of claim 1 wherein the first end is comprised of two nubs.

3. The toothbrush of claim 1 wherein the second end is comprised of a head with bristles.

4. The toothbrush of claim 1 wherein the main body is comprised of a chew-type material.

5. The toothbrush of claim 2 wherein said nubs are meant to support said toothbrush upright between paws of said dog.

6. The toothbrush of claim 3 wherein said head and said bristles are designed to reach the back teeth and gums of a dog.

7. The toothbrush of claim 6 that is also designed to be a chew toy for said dog.

8. The toothbrush of claim 1 that is designed in different sizes for small, medium, and large dogs.
